(19) United States
(12) Patent Application Publication
(10) Pub. No.: US 2020/0214480 A1
(43) Pub. Date: Jul. 9, 2020

(54) Memory Foam Pillow with a Shoulder Recess and a Riser for Height Adjustment

(71) Applicants: James Lee Haney, Cartersville, GA (US); Kimberly Haney, Cartersville, GA (US)

(72) Inventors: James Lee Haney, Cartersville, GA (US); Kimberly Haney, Cartersville, GA (US)

(21) Appl. No.: 16/241,449

(22) Filed: Jan. 7, 2019

(51) Int. Cl. A47G 9/10; H04R 25/00

(52) U.S. Cl. CPC A47G 9/1045; A47G 2009/1018; H04R 25/75; A47G 9/109

(57) ABSTRACT

A memory foam pillow with a shoulder recess and a riser for height adjustment accommodates the sleeping habits of people who prefer to sleep on their sides. The memory foam pillow includes a height-adjustable pillow and a shoulder recess. The height-adjustable pillow can be raised or lowered with the aid of a vertical riser to optimally position the user's head. The shoulder recess fits over the shoulder of the user and prevents the shoulder from compressing height-adjustable pillow. The height-adjustable pillow includes a headrest, a sound-permeable cushion, and a speaker recess. The vertical riser is connected onto a connecting side of the headrest. The user's head rests on a contact side of the headrest, opposite the connecting side. The sound-permeable cushion is mounted into the speaker recess and relieves pressure on the user's ear.

### FIELD OF THE INVENTION

The present invention relates generally to a memory foam pillow suited to the sleeping habits of people who prefer to sleep on their sides. In particular, the present invention comprises a vertical riser for raising the user's head and a shoulder recess to nestle the user's shoulder.

### BACKGROUND OF THE INVENTION

The present invention is a memory foam pillow designed for people who sleep on their sides. Users who sleep on their side have their head higher off the bed than someone who sleeps on their back or stomach. This puts the user's head at a downward angle, creating strain on the user's neck and spine. This is because conventional pillows compress by about 1.25 inches under the weight of the user's head. To compensate for this deflection, many users end up wadding the pillow, or stacking pillows, or even using their hands or arms in an attempt to the get the lost elevation back.

There are pillows in the market aimed specifically at side sleeper. However, the problem with conventional pillows designed for side sleepers, is that the distance from the neck to the shoulder is never filled by the pillow, which causes the head to drop in angle. Another issue is that lower arm doesn't have anywhere to go. One could drape it over the top of the pillow or over the head, but this leads to discomfort for the sleeper.

The present invention helps align the users neck parallel to the spine by raising the height of the pillow. This is accomplished with a riser which is attached on the pillow. The riser has a tapering shape to create a slot under the pillow for the user's arms. This gives the user a place to naturally fold the arm under the pillow without cutting off circulation to the arm. With the help of the riser, the pillow is raised to a higher position to compensate for the deflection which is caused by the weight of the user's head compressing the pillow. In the final resting position, the head is thus properly aligned with the spine. This position greatly reduces the amount of stress the neck and spine, thus leading to comfortable night of rest.

The present invention has been tested on side sleepers and has been proven to provide them with enough pillow height to keep their head and neck in a horizontal position.

Additionally, the present invention also comprises a speaker to treat users with a hearing condition called tinnitus. Sufferers of tinnitus state that nighttime is the hardest time as they have no background noise for distraction and getting to sleep is extremely difficult. Often sufferers of tinnitus resort to days of leaving the television on or running loud fans just to have a distracting sound in the background. The speaker of the present invention provides tinnitus sufferers with the ability to stream sounds directly through the pillow to provide “Sound Masking” or “Sound Distraction”. This provides them with the necessary distraction to get a sound night's sleep.

### BRIEF DESCRIPTION OF THE DRAWINGS

FIG. 1 is an exploded top perspective view of the present invention with the sound-permeable cushion and the at least one speaker removed from the speaker recess.

FIG. 2 is a bottom perspective view thereof showing the vertical riser attached to the connecting side.

FIG. 3 is an exploded side view of the present invention showing the position of the first arm-placement slot and the second arm-placement slot.

FIG. 4 is an exploded top perspective view of the present invention showing the loop portion mounted to the support side of the vertical riser.

FIG. 5 is a bottom perspective view thereof showing the hook portion mounted to the connecting side.

FIG. 6 is an exploded top perspective of present invention showing the connecting wire traversing through the headrest and connecting the speaker to the control hub.

FIG. 7 is a diagram of the electronic connection between the wireless communication module, the control module, and the speaker.

FIG. 8 is a diagram of the electric connection between the at least one power supply, the control module, the wireless communication module, and the speaker.

### DETAILED DESCRIPTION OF THE INVENTION

All illustrations of the drawings are for the purpose of describing selected versions of the present invention and are not intended to limit the scope of the present invention.

The present invention is a memory foam pillow with a shoulder recess and a riser for arm placement. The present invention allows people who sleep on their sides to place their arms under the pillow for greater support.

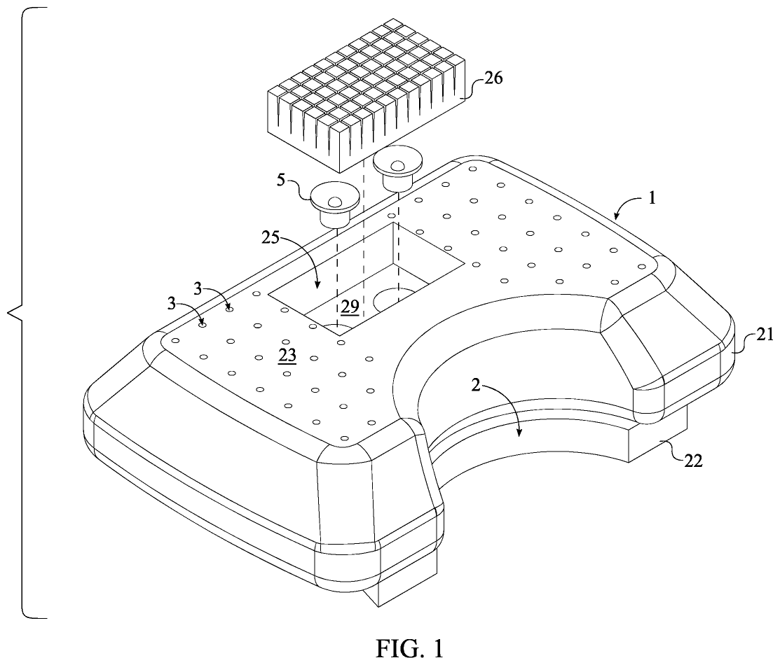

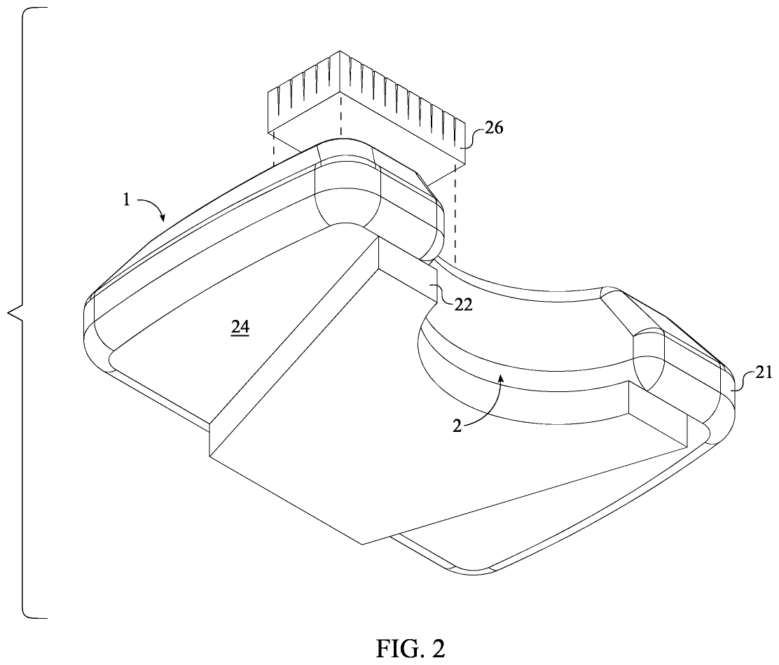

Referring to FIG. 1 and FIG. 2, the preferred embodiment of the present invention comprises a height-adjustable pillow 1 and a shoulder recess 2. The height-adjustable pillow 1 can be raised or lowered to best suit the sleeping position of a user. The shoulder recess 2 allows the height-adjustable pillow 1 to conform to the user's body. Preferably, the shoulder recess 2 is a cut made into the side of the height-adjustable pillow 1. The shoulder recess 2 prevents the height-adjustable pillow 1 from being pushed inwards by the user's shoulder, as is common with conventional pillows. This allows for greater support and comfort for the user. Accordingly, the height-adjustable pillow 1 comprises a headrest 21, a vertical riser 22, a contact side 23, a connecting side 24, a speaker recess 25, and a sound-permeable cushion 26. In the preferred embodiment, the headrest 21 is made of a memory foam material capable of conforming to the user's head, while supporting the head in the desired position. The vertical riser 22 is used to adjust the vertical position of the headrest 21. In the preferred embodiment, the vertical riser 22 is releasably attached to the headrest 21. The contact side 23 and the connecting side 24 are positioned opposite each other about the headrest 21. Preferably, the contact side 23 corresponds to the side facing towards the user, whereas the contact side 23 corresponds to the side facing the vertical riser 22.

As can be seen in FIG. 2, the shoulder recess 2 traverses through the height-adjustable pillow 1 from the contact side 23 to the connecting side 24. The shoulder recess 2 is a circular cut on the side of the headrest 21 for the user's shoulder to rest against. The vertical riser 22 allows the headrest 21 to be raised or lowered to ensure the headrest 21 contacts the user's head. As such, the vertical riser 22 is laterally attached onto the connecting side 24. Preferably, the vertical riser 22 having different heights are provided. The user can thus interchange the vertical riser 22 depending on the desired height of the headrest 21. In one possible embodiment, the vertical riser 22 may be attached with a hook-and-loop fastener. This allows the user to easily detach the vertical riser 22.

Conventional pillows tend to compress under the weight of the user's head, thus causing the neck to bend downwards and causing pain to the user. To solve this issue, the vertical riser 22 is made of a dense foam material that is more resistant to compression than the soft foam used in the headrest 21. As such, the vertical riser 22 lifts the head back up to a straight position and preserves the parallel alignment of the spine and the neck. The vertical riser 22 comes with varying thicknesses to change the height of the head rest. For example, men have broader shoulders and require a taller vertical riser 22 to properly support their head. In contrast, women have smaller shoulders and thus require a shorter vertical riser 22 to properly position their head.

As can be seen in FIG. 1, the speaker recess 25 contains at least one speaker 5 and the sound-permeable cushion 26. In the preferred implementation, the speaker recess 25 is positioned under the user's ears when the user rests on the headrest 21. Accordingly, the speaker recess 25 traverses into the height-adjustable pillow 1 from the contact side 23. This positions the speaker 5 directly under the user's ears when the user is resting against the pillow. Further, this allows the speaker 5 to play a sound directly into the user's ear. In one possible embodiment, the speaker 5 may be used to play a relaxing sound to help a user who is suffering from tinnitus. The sound-permeable cushion 26 is mounted into the speaker recess 25. The preferred embodiment of the sound-permeable cushion 26 is ¼ inch thick. The sound-permeable cushion 26 is made of a low-density foam material that relieves pressure on the user's ear and prevents pain. The sound-permeable cushion 26 is also infused with ceramic gel to help dissipate heat and keep the user's ear cool under all condition. Accordingly, the speaker 5 is mounted into a bottom surface 29 of the speaker recess 25. This allows the speaker 5 to transmit sound directly into the user's ear. A plurality of collapsible holes 3 is provided to allow the headrest 21 to collapse to inwards under the weight of the user's head. The preferred embodiment of the plurality of collapsible holes 3 is a circular hole traversing partially through the headrest 21. The plurality of collapsible holes 3 traverses into the height-adjustable pillow 1 from the contact side 23. This allows the contact side 23 to conform to the shape of the user's head.

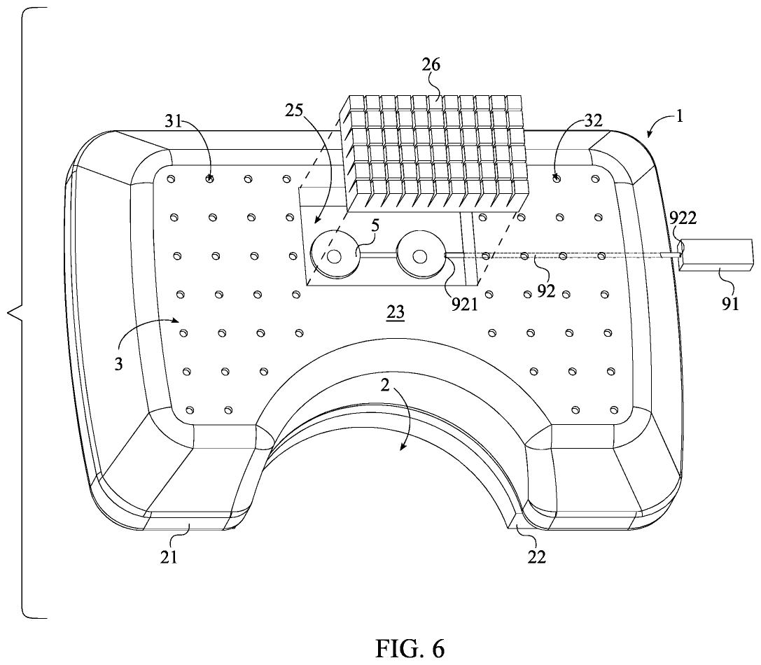

As can be seen in FIG. 6, the plurality of collapsible holes 3 consists of cylindrical cuts made into the contact side 23. Further, the plurality of holes 3 is grouped into two symmetric groups positioned opposite the speaker recess 25. As such, the plurality of collapsible holes 3 comprises a first group of holes 31 and a second group of holes 32. The first group of holes 31 is positioned adjacent to the speaker recess 25. Alternately, the second group of holes 32 is positioned adjacent to the speaker recess 25, opposite the first group of holes 31. The first group of holes 31 and the second group of holes 32 center the user's head on the headrest 21. This creates a more stable sleeping position for the user.

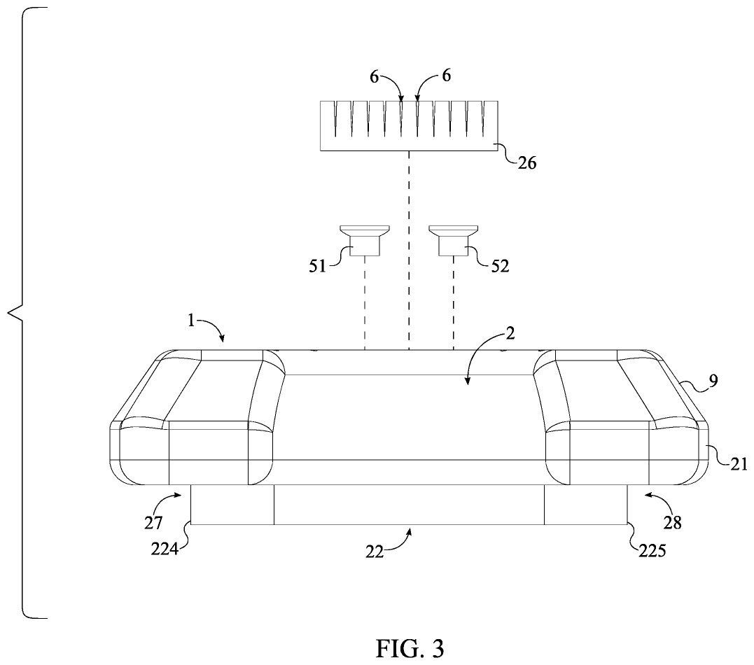

Referring to FIG. 3, in one possible embodiment of the present invention, a first arm-placement slot 27 and a second arm-placement slot 28 are provided. The first arm-placement slot 27 and the second arm-placement slot 28 allow the user to place his or her arm under the headrest 21 while sleeping on the side, thereby allowing for greater comfort and support for the user. Preferably, the user can switch between using the first arm-placement slot 27 or the second arm-placement slot 28 by switching the side that he or she is sleeping on.

In this embodiment, the first arm-placement slot 27 and the second arm-placement slot 28 are created by pushing the vertical riser 22 into the connecting side 24. Further, the vertical riser 22 acts as a partition between the first arm-placement slot 27 and the second arm-placement slot 28. As such, the vertical riser 22 comprises a first lateral side 224, a second lateral side 225, and a trapezoidal body 223. The first lateral side 224 and the second lateral side 225 are positioned opposite each other about the trapezoidal body 223. As the name implies, the first arm-placement slot 27 is delineated by the first lateral side 224 and the connecting side 24. Likewise, the second arm-placement slot 28 is delineated by the second lateral side 225 and the connecting side 24. Accordingly, this gives the first arm-placement slot 27 and the second arm-placement slot 28 a semi-circular groove shape which conforms to the user's arm. The trapezoidal body 223 is wider at the base to create space for the shoulder recess 2.

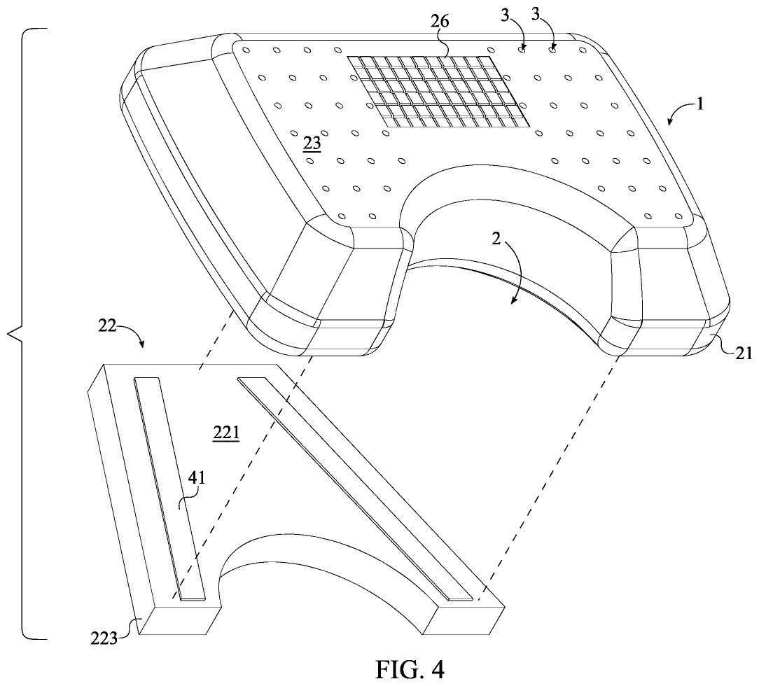

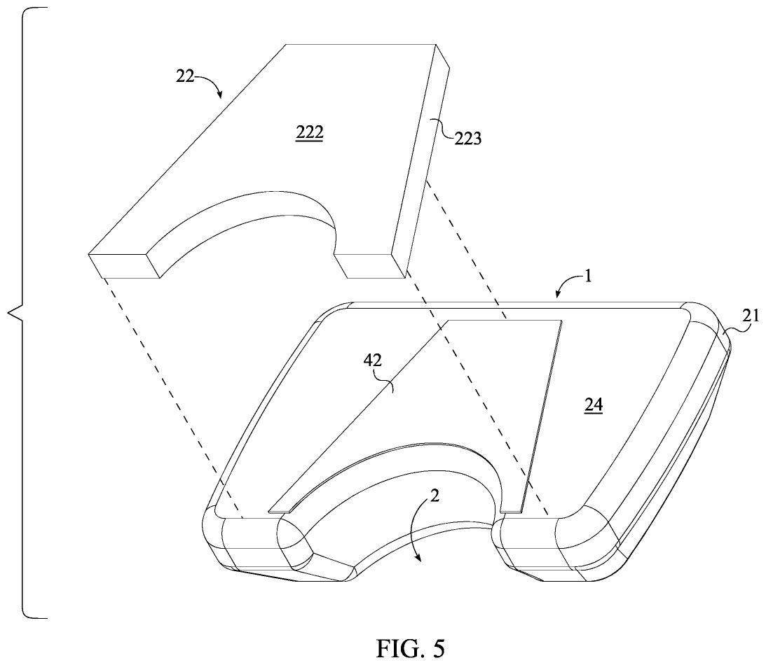

Referring to FIG. 4 and FIG. 5, a hook and loop fastener 4 is provided to attach the vertical riser 22 to the headrest 21. Accordingly, the vertical riser 22 comprises a supporting side 221, a resting side 222, and the trapezoidal body 223. The supporting side 221 and the resting side 222 are positioned opposite each other about the trapezoidal body 223. The supporting side 221 refers to the side that contacts the connecting side 24 of the height-adjustable pillow 1. In contrast, the resting side 222 refers to the side that faces away from the height-adjustable pillow 1. As such, the loop portion 42 of the hook and loop fastener 4 is mounted to the connecting side 24 of the height-adjustable pillow 1. Accordingly, the hook portion 41 of the hook and loop fastener 4 is laterally mounted to the vertical riser 22. This allows the vertical riser 22 to be attached to the connecting side 24 of the height-adjustable pillow 1 and interchanged as needed to raise or lower the position of the headrest 21.

In an alternate embodiment of the present invention, the hook portion 41 of the hook and loop fastener 4 is mounted to the connecting side 24 of the height-adjustable pillow 1. Accordingly, the loop portion 42 of the hook and loop fastener 4 is mounted onto the supporting side 221 of the vertical riser 22.

Referring back to FIG. 3, the top edge 9 of the headrest 21 is beveled to provide a flat surface for resting the user's fingers. This allows the user to grip onto the beveled top edge 9 for additional support. In particular, the beveled top edge 9 of the headrest 21 allows the user to easily place his or her fingers on the side. Preferably, the top edge 9 forms the perimeter of the headrest 21. Thus, the user can use the beveled top edge 9 while using either the first arm-placement slot 27 or the second arm-placement slot 28.

In the preferred embodiment of the present invention, the speaker 5 comprises a first speaker 51 and a second speaker 52. The first speaker 51 and the second speaker 52 are mounted into the bottom surface of the speaker recess 25. Further, the first speaker 51 and the second speaker 52 are positioned adjacent each other. Accordingly, the first speaker 51 and the second speaker 52 play amplified sound into the user's ear, thereby helping treat problems such as tinnitus.

In the preferred embodiment, the speaker 5 is configured to output sound at 17 decibels. As a result, the speaker 5 accommodates users who are hard of hearing.

Further, a plurality of cuts 6 is made into the sound-permeable cushion 26. This further aids in transmitting the sound from the speaker 5 to the user's ears. As such, the plurality of cuts 6 traverses into the sound-permeable cushion 26. Further, the plurality of cuts 6 is arranged into a grid-shaped configuration. In the preferred embodiment, the plurality of cuts 6 divide the sound-permeable cushion 26 into 1-inch by 1-inch square blocks with gaps between them. As a result, there is no single point of pressure on the ear as the contact point between the sound-permeable cushion 26 and the user's ear is always moving. Preferably, the plurality of cuts 6 only partially traverses into the sound-permeable cushion 26. This allows the sound-permeable cushion 26 to be removed and replaced in one single motion. Over time, the sound-permeable cushion 26 is likely to get hairspray or makeup on it, thus it is desirable to make the sound-permeable cushion 26 removable for cleaning or replacement.

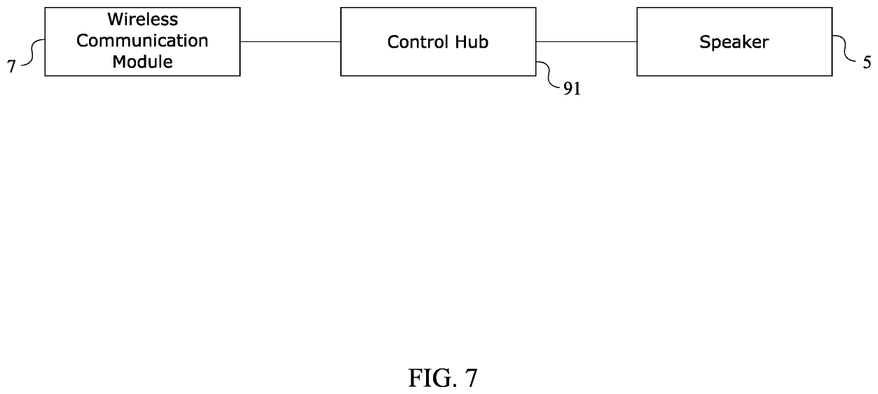

Referring to FIG. 6 and FIG. 7, a control hub 91 provides power and communication functions for the speaker 5. Further, the control hub 91 also allows wireless devices to connect to and play music through the speaker 5. Preferably, the control hub 91 is positioned external to the headrest 21. This allows the control hub 91 to receive wireless signals from wireless devices such as a wireless radio, MP3 players, laptops and the like. Accordingly, the user can play music or sounds stored in external wireless devices through the speaker 5. To achieve this, the control hub 91 is electrically connected to the speaker 5.

The electric connection is achieved via a connecting wire 92 that electrically connects the control hub 91 to the speaker 5. More specifically, the connecting wire 92 comprises a first wire end 921 and a second wire end 922. In the preferred embodiment of the present invention, the connecting wire 92 is a 3.5 mm jack with a plug at each end. As such, the first wire end 921 and the second wire end 922 each has a plug capable of connecting to an electronic device. Preferably, the first wire end 921 is electrically connected to the speaker 5. Since the speaker 5 is mounted within the headrest 21, the connecting wire 92 traverses from the speaker recess 25 and through the headrest 21 so that the second wire end 922 can be externally positioned to the headrest 21. As such, the second wire end 922 is electrically connected to the control hub 91.

Referring to FIG. 7, a wireless communication module 7 allows wireless devices to connect and play sounds through the speaker 5. In the preferred embodiment of the present invention, the wireless communication module 7 is electronically integrated into the control hub 91. More specifically, the wireless communication module 7 is a radio frequency (RF) transceiver mounted within the control hub 91. As such, the wireless communication module 7 connects to the surrounding wireless devices such as smartphones, MP3 players, and laptops, in order to stream music through the speaker 5. This allows the user to stream any app or music directly through the speaker 5 in the speaker recess 25.

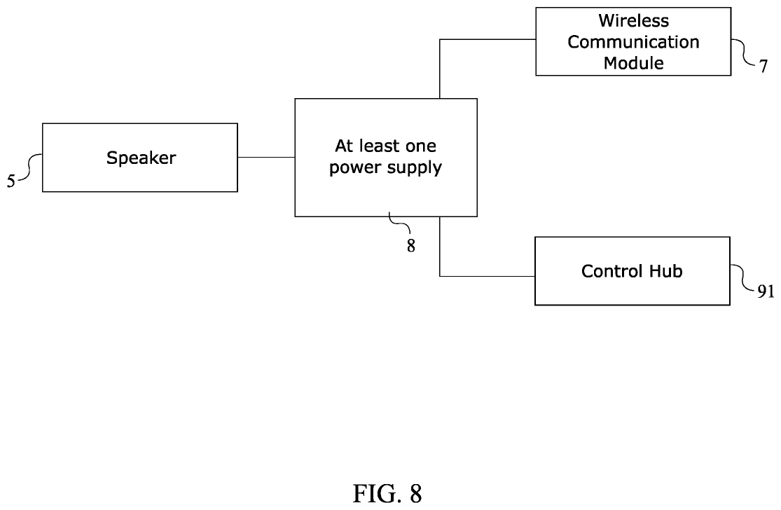

Referring to FIG. 8, at least one power supply 8 powers the electrically operated components of the present invention. As such, the at least one power supply 8 is electrically integrated into the control hub 91. Accordingly, the at least one power supply 8 transmits both power and sound to the speaker 5. For example, the at least one power supply 8 may be a battery cell removably mounted into the control hub. This allows the at least one power supply 8 to be replaced and recharged as seen fit.

Although the invention has been explained in relation to its preferred embodiment, it is to be understood that many other possible modifications and variations can be made without departing from the spirit and scope of the invention as hereinafter claimed.

What is claimed is:

1. A memory foam pillow with a shoulder recess and a riser for height adjustment comprises:
a height-adjustable pillow;
a shoulder recess;
the height-adjustable pillow comprises a headrest, a vertical riser, a contact side, a connecting side, a speaker recess, and a sound-permeable cushion;
the contact side and the connecting side being positioned opposite each other about the headrest;
the shoulder recess traversing through the height-adjustable pillow from the contact side to the connecting side;
the vertical riser being laterally attached onto the connecting side;
the speaker recess traversing into the height-adjustable pillow from the contact side; and
the sound-permeable cushion being mounted into the speaker recess.

2. The memory foam pillow with a shoulder recess and a riser for height adjustment as claimed in claim 1 comprises:
at least one speaker; and
the speaker being mounted into a bottom surface of the speaker recess.

3. The memory foam pillow with a shoulder recess and a riser for height adjustment as claimed in claim 1 comprises:
a plurality of collapsible holes; and
the plurality of collapsible holes traversing into the height-adjustable pillow from the contact side.

4. The memory foam pillow with a shoulder recess and a riser for height adjustment as claimed in claim 3 comprises:
the plurality of collapsible holes comprises a first group of holes and a second group of holes;
the first groups of holes being positioned adjacent to the speaker recess; and
the second group of holes being positioned adjacent to the speaker recess, opposite the first group of holes.

5. The memory foam pillow with a shoulder recess and a riser for height adjustment as claimed in claim 1 comprises:
a first arm-placement slot;
a second arm-placement slot;
the vertical riser comprises a first lateral side, a second lateral side, and a trapezoidal body;
the first lateral side and the second lateral side being positioned opposite each other about the trapezoidal body;
the first arm-placement slot being delineated by the first lateral side and the connecting side; and
the second arm-placement slot being delineated by the second lateral side and the connecting side.

6. The memory foam pillow with a shoulder recess and a riser for height adjustment as claimed in claim 1 comprises:
a hook and loop fastener;
the vertical riser comprises a supporting side, a resting side, and a trapezoidal body;
the supporting side and the resting side being positioned opposite each other about the trapezoidal body;
the hook portion of the hook and loop fastener being mounted to the connecting side of the height-adjustable pillow; and
the loop portion of the hook and loop fastener being mounted onto the supporting side of the vertical riser.

7. The memory foam pillow with a shoulder recess and a riser for height adjustment as claimed in claim 1 comprises:
a hook and loop fastener;
the vertical riser comprises a supporting side, a resting side, and a trapezoidal body;
the supporting side and the resting side being positioned opposite each other about the trapezoidal body;
the loop portion of the hook and loop fastener being mounted to the connecting side of the height-adjustable pillow; and
the hook portion of the hook and loop fastener being laterally mounted to the vertical riser.

8. The memory foam pillow with a shoulder recess and a riser for height adjustment as claimed in claim 1, wherein the top edge of the headrest is beveled.

9. The memory foam pillow with a shoulder recess and a riser for height adjustment as claimed in claim 1 comprises:
at least one speaker;
the speaker comprises a first speaker and a second speaker; and
the first speaker and the second speaker being mounted into the bottom surface of the speaker recess.

10. The memory foam pillow with a shoulder recess and a riser for height adjustment as claimed in claim 9, wherein the speaker is configured to output sound at 17 decibels.

11. The memory foam pillow with a shoulder recess and a riser for height adjustment as claimed in claim 1 comprises:
a plurality of cuts;
the plurality of cuts traversing into the sound-permeable cushion; and
the plurality of cuts being arranged into a grid-shaped configuration.

12. The memory foam pillow with a shoulder recess and a riser for height adjustment as claimed in claim 1 comprises:
at least one speaker;
a control hub;
the control hub being positioned external to the headrest; and
the control hub being electrically connected to the speaker.

13. The memory foam pillow with a shoulder recess and a riser for height adjustment as claimed in claim 12 comprises:
a connecting wire;
the connecting wire comprises a first wire end and a second wire end;
the first wire end being electrically connected to the speaker;
the connecting wire traversing from the speaker recess and through the headrest; and
the second wire end being electrically connected to the control hub.

14. The memory foam pillow with a shoulder recess and a riser for height adjustment as claimed in claim 12 comprises:
a wireless communication module; and
the wireless communication module being electronically integrated into the control hub.

15. The memory foam pillow with a shoulder recess and a riser for height adjustment as claimed in claim 12 comprises:
at least one power supply; and
the power supply being electrically integrated into the control hub.
